(19) United States
(12) Patent Application Publication
(10) Pub. No.: US 2006/0044797 A1
(43) Pub. Date: Mar. 2, 2006

(54) Lighting device securable to a support structure

(76) Inventors: Mary Gallagher Steady, Cape May, NJ (US); Jacqueline Maric Steady, Cape May, NJ (US)

Correspondence Address: Jacqueline M. Steady, Esq., 1021 Cape May Ave, Cape May, NJ, 08204, US

(21) Appl. No.: 10/925,484

(22) Filed: Aug. 25, 2004

(51) Int. Cl. F21V 33/00

(52) U.S. Cl. 362/253

(57) ABSTRACT

A lighting device comprising a lighting unit, a housing supporting the lighting unit, an activation unit for activating the lighting unit and a strap for securing the housing to a respective support structure. Alternatively, a sleeve may be used to secure a housing to a respective support structure.

### BACKGROUND OF THE INVENTION

The present invention relates to a lighting device securable to a support structure, such as a handlebar of a bicycle.

It is known to use a rigid lighting unit for a support structure where power circuitry is included in the support structure.

### SUMMARY OF THE INVENTION

It is an advantage of the invention that a lighting device is provided with a variable fitting device for securing a housing of a lighting device to a support structure.

It is another advantage of the invention that power circuitry is external to any support structure, such as a bicycle handlebar.

It is another advantage of the invention that a power source may be included in the housing of the lighting device.

It is yet another advantage of the present invention that finishing surfaces and protective grips of support structures need not be altered in conjunction with a lighting device according to the present invention.

It is another advantage of the invention that an activation unit is available external to the housing.

It is still another advantage that an activation unit is remote to the housing.

It is yet still another advantage that a housing of a lighting device according to the present invention rests on a respective securing device for securing to a respective support structure.

It is another advantage of the present invention that the lighting device may be activated without removing a hand from a respective support structure when a user is gripping the support structure, such as a handlebar.

It is another advantage of the present invention that a housing of the lighting device may be contoured to complement a respective support structure.

It is another advantage of the present invention that a housing of the lighting device may include a grip or cushion for contact with a support structure.

It is an advantage of an embodiment of the present invention that the lighting unit is securable at any point along an entire support structure as opposed to only a distal end of a support structure.

### BRIEF DESCRIPTION OF THE DRAWINGS

FIG. 1 shows a first embodiment of the present invention;

FIG. 2a shows a partial side view of the present invention;

FIG. 2b shows a top view of a housing extension with braces; and

FIG. 3 shows a second embodiment of the present invention.

### DETAILED DESCRIPTION OF THE INVENTION

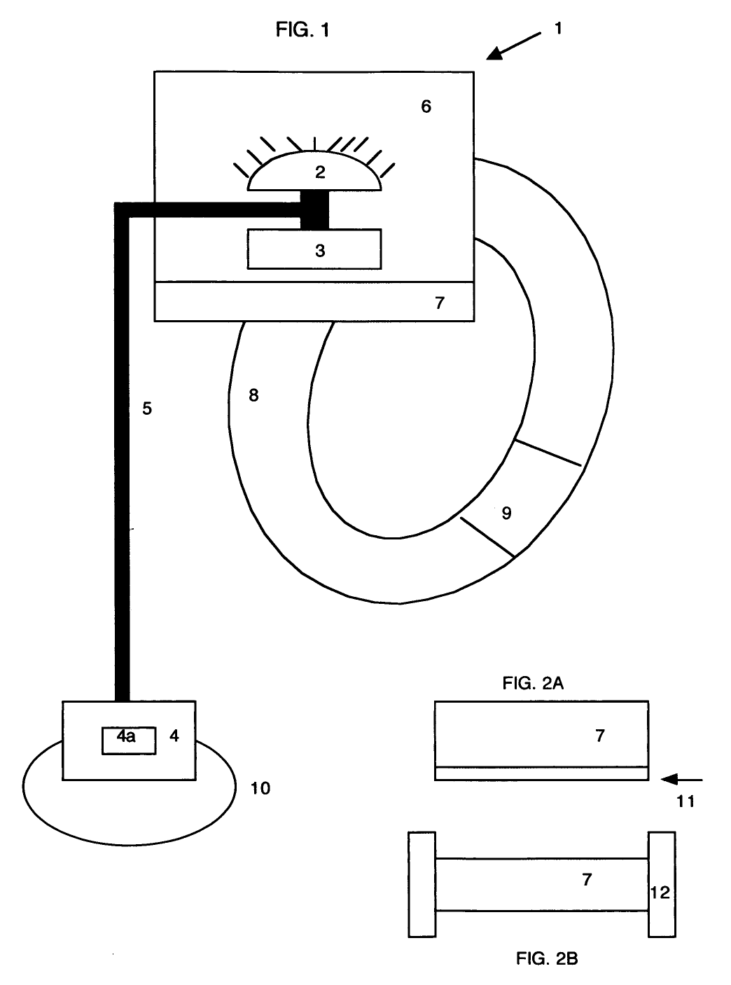

The best mode of the invention is shown in FIG. 1. FIG. 1 shows a lighting device 1 for securing to a support structure such as a handlebar of bike, or a bar or a pole. The lighting device includes a lighting unit and activation unit. The lighting device includes light emission source 2 with power circuitry 3. Light emission source 2 may be replaceable. Power circuitry 3 may include a replaceable or rechargeable power supply. Activation unit 4 activates light emission source 2 through communication path 5. Path 5 may be either a hard wired communication path or a wireless communication path with light emission source 2 and power circuitry 3 and is insulated as necessary and desired. Activation unit 4 may, either alone or in combination, activate constant light emission, blinking light emission, or no light emission.

Lighting device 1 includes housing base 6 and housing extension 7. Housing extension 7 may be integral with housing base 6 or removably secure to housing base 6. Housing base 6 and/or housing extension 7 may compliment the shape and or size of a respective support structure. Housing base 6 includes a transparent region for allowing light emission to pass there through. At least light emission source 2 is internal to housing base 6. Light source 2 may be integral with housing base 6. Housing base 6 and/or housing extension 7 include respective access areas for replacing light emission source 2 and a respective power source of power circuitry 3. Housing base 6 and housing extension 7 are designed to protect light emission source 2, power circuitry 3 and communication path 5 against elements as desired and necessary.

Extension 7 is designed to include a region for receiving strap 8. Strap 8 secures to a respective support structure, by tying, by having elasticity, or with a closure device, for example. Strap 8 may include closure 9. Closure 9 may include any of a velcro® hook and fastener closure, a snap closure, a tie closure, a brace closure, a bracket closure, a rubber closure and a clasp closure alone or in combination. Strap 8 may be wrapped around variable sizes and shapes.

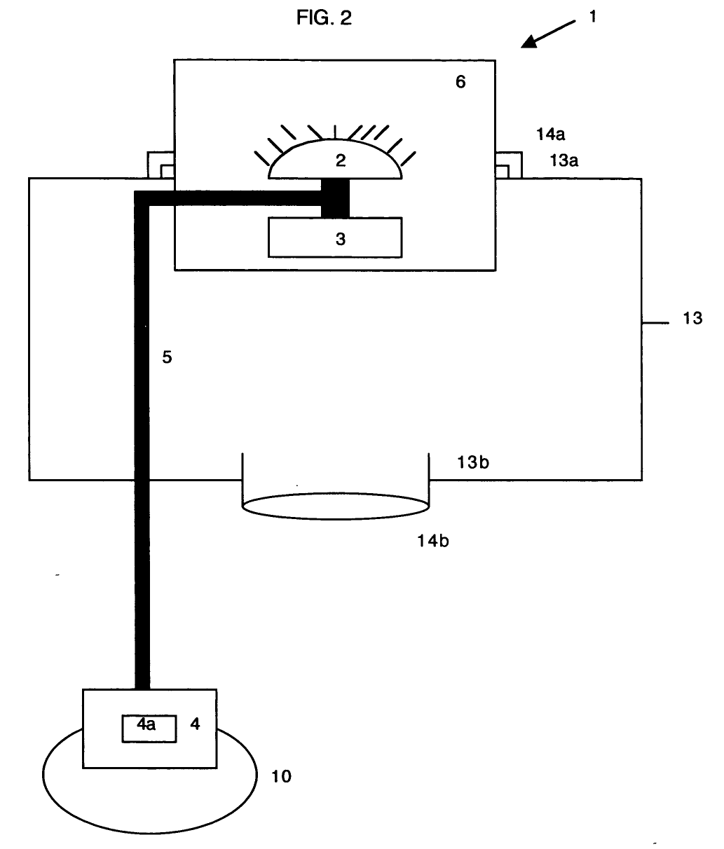

Housing extension 7 may be contoured. Such a contour could complement a shape of a respective support structure. A concave contour could be use for a cylindrical support structure. In addition, as shown in FIG. 2a, a grip and/or cushion 11 may be secured on housing extension 7 for gripping and/or cushioning against a respective support structure. Housing extension 7 may also include braces 12 for further complementing a respective support structure. Braces 12 may be contoured as necessary and desired and may include grips as necessary and desired.

Activation unit 4 activates constant light emission, blinking light emission or no light emission, independently or in sequence. Activation unit 4 may include a switch, such as a push-on activator 4a or a toggle switch 4a. Activation unit 4 is designed to protect against elements as necessary and desired. It is possible to include power circuitry in the activation source. Activation unit 4 may be accompanied by securing element 10 to secure activation unit 4 to a respective support structure such as a handle bar, bar or pole. Securing element 10 may secure to a support structure by tying, by having elasticity, or with a closure device, for example. Activation unit 4 may be strapped on a user's body or wrist. Of course, there may be the occasion where a user wishes to carry or hold the activation unit without securing the activation unit to a support structure.

Embodiment 2 indicates like elements with the same reference numerals. In embodiment 2, lighting device 1 is secured to a respective support structure with a sleeve 13, see FIG. 3. Sleeve 13 may be secured to variable sizes and shapes of housings and support structures and may be designed to compliment a support structure. Sleeve 13 may be a rigid sleeve or a flexible sleeve, such as rubber or cloth sleeve. Sleeve 13 may be designed to include securing elements 13a and 13b to secure a housing and support structure. Additional securing elements 14a and 14b, such as a strap and closure device may be used to reinforce securing elements 13a and 13b or replace elements 13a and 13b.

Of course, a plurality of lighting units, housings and straps or sleeves may be used with a single activation unit.

Although the foregoing description of the preferred embodiments of the present invention have been shown and described, it will be understood that various omissions, substitutions, and changes in the form of the detail of the apparatus as illustrated, as well as uses thereof, may be made by those skilled in the art, without departing from the spirit of the present invention. Many variations of the invention within the scope of the appended claims will be apparent to those skilled in the art.

We claim:

1.) A lighting device comprising:
a lighting unit;
a housing supporting said lighting unit;
an activation unit for activating said lighting unit;
a first strap for securing said housing to a respective support structure; and
a second strap for securing said activation unit to said respective support structure or another support structure.

2.) A lighting device according to claim 1, further comprising said lighting unit including a replaceable light emission source.

3.) A lighting device according to claim 1, further comprising said housing having a transparent region.

4.) A lighting device according to claim 1, further comprising said housing having a receiving region for receiving said strap.

5.) A lighting device according to claim 1, further comprising said housing including:
a housing base;
a housing extension for receiving said strap; and
said housing extension being removably securable to said housing base region.

6.) A lighting device according to claim 1, further comprising said housing having a region for permitting light emission source replacement.

7.) A lighting device according to claim 1, further comprising said housing having a region for permitting power source replacement.

8.) A lighting device according to claim 1, further comprising:
said housing having a first side; and
said first side being contoured for complementing a respective shapes of a respective support structure.

9.) A lighting device according to claim 1, further comprising:
said housing having a first side; and
at least one of a grip or cushion secured on said first side.

10.) A lighting device according to claim 1, further comprising:
said housing having a first side; and
at least one brace extending outward from said first side.

11.) A lighting device according to claim 1, further comprising:
said activation unit being hard wired to said lighting unit; and
said housing having a region for receiving said hard wiring of said activation unit.

12.) A lighting device according to claim 1, further comprising said activation unit being hard wired to said lighting unit.

13.) A lighting device according to claim 1, further comprising said activation unit activating said lighting unit through wireless activation.

14.) A lighting device according to claim 1, further comprising said activation unit activating said lighting unit for sequential constant emission, blinking light emission and no emission.

15.) A lighting device according to claim 1, further comprising said activation unit activating constant emission of said lighting unit.

16.) A lighting device according to claim 1, further comprising said activation unit activating blinking emission of said lighting unit.

17.) A lighting device according to claim 1, further comprising said activation unit activating no emission of said lighting unit.

18.) A lighting device according to claim 1, further comprising said activation unit including a push on activation switch.

19.) A lighting device according to claim 1, further comprising said activation unit including a toggle activation switch.

20.) A lighting device according to claim 1, further comprising said activation unit being releasably secure to a respective support structure.

21.) A lighting device according to claim 1, further comprising said first strap having an elasticity.

22.) A lighting device according to claim 1, further comprising said first strap having a closure device.

23.) A lighting device according to claim 22, further comprising said closure device including a velcro® closure.

24.) A lighting device according to claim 22, further comprising said closure device including a snap closure.

25.) A lighting device according to claim 1, further comprising:
said lighting unit including a plurality of lighting units;
said housing including a plurality of housings for supporting said plurality of lighting units, respectively; and
said first strap including a plurality of first straps for securing said plurality of housings to respective support structures, respectively.

26.) A lighting device comprising:
a lighting unit including a light emission source and power circuitry;
a housing supporting said lighting unit including said light emission source and power circuitry;
an activation unit for activating said lighting unit; and
a first strap with closure or having elasticity for securing said housing to a respective support structure.

27.) A lighting device according to claim 26, further comprising:
said lighting unit including a plurality of lighting units each having a respective light emission source and power circuitry;
said housing including a plurality of housing for supporting said plurality of lighting units, respectively; and
said first strap with closure or having elasticity including a plurality of first straps with respective closures or having elasticity for securing said plurality of housings to respective support structures, respectively.

28.) A lighting device comprising:
a lighting unit;
a housing supporting said lighting unit;
an activation unit for activation said lighting unit; and
a sleeve for securing said housing to a respective support structure.

29.) A lighting device according to claim 28, further comprising said lighting unit including a replaceable light emission source.

30.) A lighting device according to claim 28, further comprising said lighting unit including a replaceable power source.

31.) A lighting device according to claim 28, further comprising said housing having a transparent region.

32.) A lighting device according to claim 28, further comprising said housing having a region for permitting light emission source replacement.

33.) A lighting device according to claim 28, further comprising said housing having a region for permitting power source replacement.

34.) A lighting device according to claim 28, further comprising:
said housing having a first side; and
said first side being contoured for complementing a respective shape of a respective support structure.

35.) A lighting device according to claim 28, further comprising:
said housing having a first side; and
at least one of a grip or cushion secured on said first side.

36.) A lighting device according to claim 28, further comprising:
said activation unit being hard wired; and
said housing having a region for receiving said hard wiring of said activation unit.

37.) A lighting device according to claim 28, further comprising said activation unit being hard wired to said lighting unit.

38.) A lighting device according to claim 28, further comprising said activation unit activating said lighting unit through wireless activation.

39.) A lighting device according to claim 28, further comprising said activation unit activating said lighting unit for sequential constant light emission, blinking light emission and no light emission.

40.) A lighting device according to claim 28, further comprising said activation unit activating constant light emission of said lighting unit.

41.) A lighting device according to claim 28, further comprising said activation unit activating blinking light emission of said lighting unit.

42.) A lighting device according to claim 28, further comprising said activation unit activating no light emission of said lighting unit.

43.) A lighting device according to claim 28, further comprising said activation unit including a push on activation switch.

44.) A lighting device according to claim 28, further comprising said activation unit including a toggle activation switch.

45.) A lighting device according to claim 28, further comprising said activation unit being releasably secure to a respective support structure.

46.) A lighting device according to claim 28, further comprising said sleeve being able to receive support structures having variable sizes and shapes.

47.) A lighting device according to claim 28, further comprising at least one first securing element.

48.) A lighting device according to claim 28, further comprising at least one first securing element and at least one additional securing element.

49.) A lighting device according to claim 48, further comprising at least one of said at least one first securing element and said at least one additional securing element including a closure device.

50.) A lighting device according to claim 28, further comprising:
said lighting unit including a plurality of lighting units;
said housing including a plurality of housings for supporting said plurality of lighting units respectively; and
said sleeve including a plurality of sleeves for securing said plurality of housings to respective support structures.
